(19) United States
(12) Patent Application Publication
(10) Pub. No.: US 2004/0020514 A1
(43) Pub. Date: Feb. 5, 2004

(54) Probe device cleaner and method

(76) Inventor: James E. Orsillo, Bend, OR (US)

Correspondence Address: KLARQUIST SPARKMAN, LLP, 121 SW SALMON STREET, SUITE 1600, PORTLAND, OR, 97204, US

(21) Appl. No.: 10/439,595

(22) Filed: May 16, 2003

Related U.S. Application Data
(60) Provisional application No. 60/397,167, filed on Jul. 18, 2002.

(51) Int. Cl. B08B 1/00

(52) U.S. Cl. 134/6; 15/21.1

(57) ABSTRACT

Embodiments of an apparatus and method for cleaning the probes of a probe device are disclosed. In an illustrated embodiment, a cleaning apparatus comprises a cleaning member having a cleaning surface and a support member for supporting the cleaning member. An adjustment mechanism is operable to adjust the tilt orientation of the cleaning surface relative to the probe tips to maximize contact between the probe tips and the cleaning surface when the probe tips are rubbed against the cleaning surface to remove debris therefrom. In particular embodiments, the adjustment mechanism comprises one or more adjusting screws and one or more corresponding hold-down screws extending generally co-axially through the adjusting screws.

### CROSS-REFERENCE TO RELATED APPLICATION

This application claims priority to U.S. Provisional Application No. 60/397,167, filed Jul. 18, 2002, which is incorporated herein by reference.

### FIELD

The present invention relates to an apparatus for cleaning the probes of a probe device (e.g., a probe card) used to test the electrical characteristics of electrical devices, such as integrated circuits on a semiconductor wafer.

### BACKGROUND

In the manufacture of semiconductor devices, multiple semiconductor devices are formed on a semiconductor wafer, and then divided into portions to separate the semiconductor devices from each other. Typically, before dividing the wafer, the electrical characteristics of each semiconductor device is tested.

In the testing process, a device called a probe card is used to electrically connect the semiconductor devices with a tester. The probe card has multiple probes, usually in the form of elongated needles, which are configured to register with respective electrode pads of the semiconductor devices. To achieve a satisfactory electrical connection between each probe and a respective electrode pad, the probes are brought into contact with and are caused to “scrub,” or penetrate, the layer of oxide formed on the electrode pads. When scrubbing occurs, debris, such as small chips of aluminum oxide, accumulates on the ends of the probes and eventually obstructs the electrical connection in subsequent testing.

To ensure an adequate electrical connection, the ends of the probes must be periodically cleaned to remove any debris that has accumulated on the probes. In a common approach for cleaning the probes of a probe card, the ends of the probes are brought into contact with an abrasive plate or pad, and the probes are moved relative to the plate to cause the ends of the probes to scrape or rub against the plate to remove foreign matter from the probes.

A conventional abrasive-type cleaning apparatus is illustrated in FIG. 1. In this configuration, a probe card 10 having a plurality of probes 12 is supported such that the probe tips, or ends, 14 contact a cleaning disk 16 made from an abrasive material. The cleaning disk 16 is supported on a support member 18. The support member 18 is mounted to a bracket 20 with spacers 28 interposed between the support member 18 and the bracket 20. The support member 18 may include a magnet 22 disposed in a centrally located hole. The magnet 22 is positioned to magnetically couple to a magnetic piece 26 attached to the lower surface of the cleaning disk 16, thereby magnetically coupling the cleaning disk and the support member together. A pin 24 extending from the lower surface of the cleaning disk 16 is received in a corresponding hole in the support member 18. Pin 24 and magnetic piece 26 retain the cleaning disk 16 from moving relative to the support member 18 during cleaning of the probes 12. The bracket 20 typically is coupled to or adjacent a probe station (not shown) in which the probe card 10 is used to test semiconductor devices.

To clean the probe tips 14 of debris accumulated thereon during testing, the probe card 10 is moved relative to the cleaning disk 16 (e.g., in a lateral, side-to-side motion or in a circular motion). Typically, the probe tips 14 do not wear evenly so that after several testing and cleaning cycles, one or more of the probe tips 14 may not contact the upper surface of the cleaning disk 16 during cleaning.

To address this problem, an operator typically will adjust the tilt orientation of the cleaning disk 16 relative to the probe tips 14 to maximize contact between the cleaning disk and the probe tips. The orientation of the cleaning disk is adjusted by first removing the cleaning disk 16 and the support member 18 from the bracket 20 and then selectively sanding away material from the upper surface of one or more of the spacers 28 with an abrasive material.

As can be appreciated, the foregoing approach is time consuming and cannot achieve a high degree of precision. In addition, sanding the spacers 28 generates airborne particles that can easily contaminate the semiconductor devices under test. Accordingly, there exists a need for a new and improved apparatus and method for cleaning the probes of a probe device.

### SUMMARY

To such ends, and according to one aspect, a cleaning apparatus for cleaning the probes of a probe device has an adjustment mechanism that can be used to adjust the tilt orientation of a cleaning surface to position the cleaning surface in a plane that maximizes contact with the probes during cleaning.

In one representative embodiment, a cleaning apparatus for a probe device comprises a cleaning member having a cleaning surface for cleaning the probes of the probe device and a support member for supporting the cleaning member. An adjustment mechanism is operable to adjust the tilt orientation of the cleaning surface relative to the probe tips to maximize contact between the probe tips and the cleaning surface when the probe tips are cleaned on the cleaning surface to remove debris therefrom.

In particular embodiments, the adjustment mechanism comprises one or more adjusting screws and one or more corresponding hold-down screws. Each adjusting screw extends through the cleaning member and bears against an adjacent surface of the support member such that rotation of an adjusting screw changes the tilt orientation of the cleaning surface of the cleaning member. Each hold-down screw extends generally coaxially through a respective adjusting screw into the support member. When the adjusting screws are set are their desired positions, the hold-down screws can be tightened into the support member to retain the cleaning member on the support member.

In some embodiments, the cleaning member comprises a base portion and a removable cleaning element carried by the base portion, with the cleaning element defining the cleaning surface for contacting and cleaning the probe tips. In particular embodiments, the base portion is adjustable relative to the support member by the adjusting screws and is releasably retained to the support member by the hold-down screws. Desirably, the cleaning element comprises a magnetic material, such as tungsten carbide, and is magnetically retained to the base portion by one or more magnets disposed in corresponding openings in the base portion.

In certain embodiments, the base portion has a recessed portion for receiving the cleaning element and a rim extending at least partially around the recessed portion and the cleaning member to prevent lateral movement of the cleaning element relative to the base portion when the probes are cleaned on the cleaning surface.

In an illustrated embodiment, the support member includes an alignment pin that extends into a corresponding opening in the cleaning member. The alignment pin maintains alignment of the cleaning member relative to the support member when the hold-down screws are loosened to permit adjustment of the adjusting screws.

In another representative embodiment, an apparatus for cleaning a probe device comprises a support member and a cleaning member carried by the support member for contacting and cleaning the probes of the probe device. An adjustment mechanism is configured to adjust the tilt orientation of the cleaning member relative to the probes and to secure the cleaning member to the support member without creating a bending moment in the cleaning member.

In another representative embodiment, an apparatus for cleaning a probe device comprises a support member and two or more cleaning members supported by the support member. Each cleaning member has a cleaning surface for cleaning the probes of a probe device and is independently adjustable to adjust the planarity of its respective cleaning surface relative to the probes. In particular embodiments, each cleaning member comprises a cleaning chuck, a removable cleaning element, and an adjustment mechanism for adjusting the planarity of the cleaning element relative to the probes.

In still another representative embodiment, an apparatus for cleaning a probe device having a plurality of probes comprises a cleaning chuck having a recessed portion. A removable cleaning element for contacting and cleaning the probes is dimensioned to be received in the recessed portion.

In another representative embodiment, an apparatus for cleaning a probe device having a plurality of probes comprises a support member, a cleaning member carried by the support member for contacting and cleaning the probes, and means for planarizing the cleaning member relative to the probes and for securing the cleaning member to the support member while maintaining the planarity of the cleaning member.

In another representative embodiment, a method for cleaning the probe tips of a probe device used in testing semiconductor devices comprises providing a cleaning device having a cleaning surface for contacting and cleaning the probe tips. The tilt orientation of the cleaning device relative to the probe tips is adjusted to maximize contact between the probe tips and the cleaning surface during cleaning. After the cleaning device is set at a desired orientation, the cleaning device is secured to a support member without creating a moment in the cleaning device so as to maintain the planarity of the cleaning surface relative to a plane defined by the probe tips. Thereafter, the probe tips are cleaned with the cleaning device, such as by rubbing the probe tips against the cleaning surface.

In another representative embodiment, an apparatus for moving a first body relative to a second body comprises a first screw and a second screw. The first screw is adapted to be received in a threaded opening in the first body and bear on an adjacent surface of the second body such that rotation of the first screw causes the first body to move relative to the second body. The second screw extends generally co-axially through the first screw and has a threaded portion adapted to be tightened into a corresponding threaded opening in the second body. Once the first screw is adjusted to create a desired spacing between opposing surfaces of the first and second bodies, the second screw can be tightened into the second body to couple the first body to the second body.

The foregoing and other features and advantages of the invention will become more apparent from the following detailed description of several embodiments, which proceeds with reference to the accompanying figures.

### BRIEF DESCRIPTION OF THE DRAWINGS

FIG. 1 is a side view of a prior art cleaning apparatus having an abrasive cleaning disk for cleaning the probe tips of a probe card.

FIG. 2 is a perspective view of an apparatus for cleaning the probe tips of a probe card according one embodiment.

FIG. 3 is a top plan view of the cleaning member of the apparatus of FIG. 2, with the cleaning element shown in phantom to reveal the upper surface of the base portion of the cleaning member.

FIG. 4 is an elevation view of the cleaning member and the support member of the apparatus of FIG. 2, with the cleaning member shown in section.

FIG. 5 is a partial, cross-sectional view taken along line 5-5 of FIG. 3.

FIG. 6 is a partial, cross-sectional view taken along line 6-6 of FIG. 3.

FIG. 7 is a perspective view of another embodiment of an apparatus for cleaning the probe tips of a probe card.

FIG. 8 is an elevation view of the cleaning member and the support member of the apparatus of FIG. 7, with the cleaning member shown in section.

FIG. 9 is a bottom plan view of the apparatus of FIG. 7.

FIG. 10 is a perspective view of another embodiment of an apparatus for cleaning the probe tips of a probe card.

FIG. 11 is an elevation view of the apparatus of FIG. 10, with the cleaning members shown in section.

### DETAILED DESCRIPTION

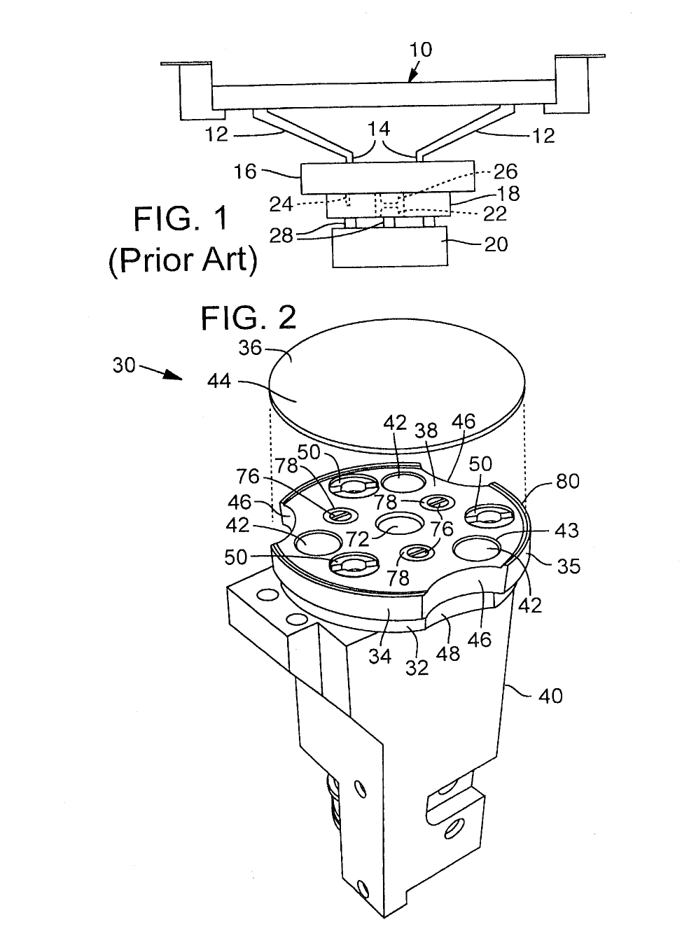

Referring first to FIGS. 2 and 4, there is shown a cleaning apparatus 30, according to one embodiment, for removing debris that has accumulated on the probe tips of a probe device, such as the probe card 10 shown in FIG. 1. The cleaning apparatus 30 in the illustrated configuration includes a support member 32 and a cleaning member 34 (also referred to herein as a cleaning device) coupled to the support member 32. The cleaning apparatus 30 can be mounted to a support bracket 40 (FIG. 1), which in turn can be mounted to a probe station (not shown) or other equipment adjacent to the probe station being used to test semiconductor devices.

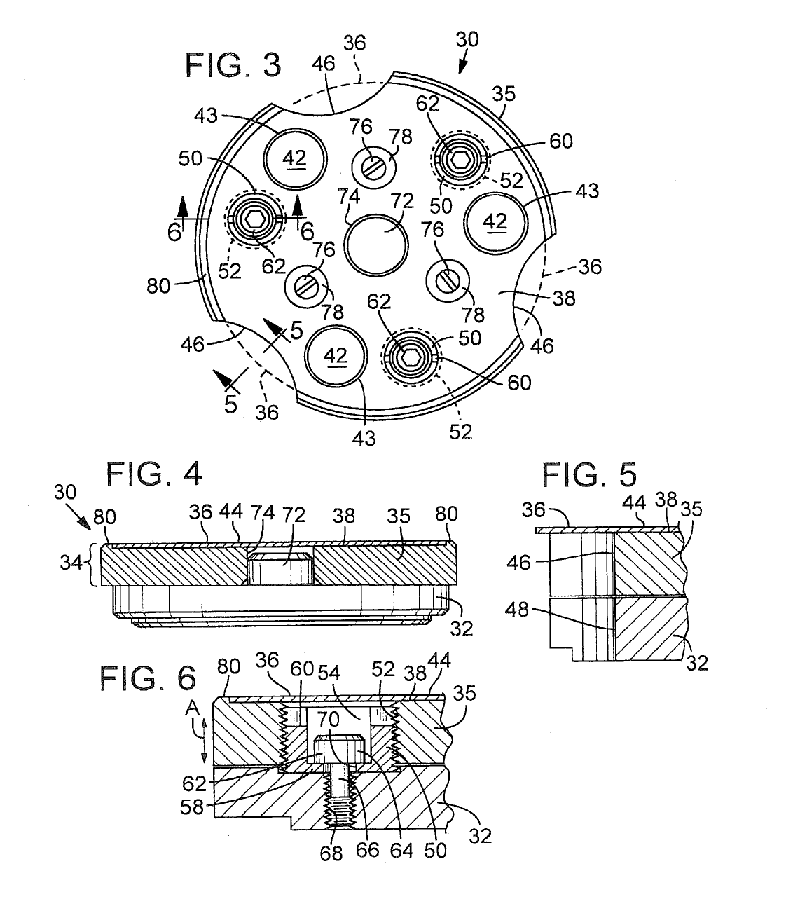

The cleaning member 34 comprises a base portion 35 (also referred to herein as a cleaning chuck and an adjustable portion) and a removable cleaning element 36 dimensioned to fit in a recessed portion, or area of reduced thickness, 38 formed on the upper surface of the base portion 35 (FIGS. 2 and 3). The cleaning element 36 has a cleaning surface 44 (the upper surface in the illustrated embodiment) (FIGS. 2 and 4) for contacting and cleaning the probe tips of a probe card. A rim, or lip portion, 80 of the base portion 35 at least partially surrounds the recessed portion 38. The rim 80 facilitates alignment of the cleaning element 36 when it is placed on the base portion 35 and prevents lateral movement of the cleaning element 36 relative to the base portion 35 when the probe tips are rubbed against the cleaning surface 44.

In the illustrated embodiment, the base portion 35 and support member 32 are generally circular and the cleaning element 36 comprises a generally annular disc. However, the shapes of these components are not limited to those shown in the illustrated embodiment. Accordingly, cleaning element 36, base portion 35, and support member 32 may comprise any other geometric shape, such as a square or rectangle or any combination or variation thereof.

The cleaning element 36 can be made from any material suitable for cleaning the probe tips of a probe device. In the illustrated embodiment, for example, the cleaning element 36 is an abrasive plate that removes debris adhering to the probe tips by the grinding action of the probe tips against the surface of the cleaning element. Some examples of suitable abrasive materials that can be used for the cleaning element 36 include, without limitation, tungsten carbide, stainless steel, or ceramic. If desired, abrasive tapes (e.g., such as available from 3M Corp.) or papers (e.g., alumina or diamond coated papers), may be secured to the cleaning surface 44 of the cleaning element 36 for contact with the probe tips. Also, tacky paper having a tacky adhesive surface for removing debris from the probe tips can be used. If any of the foregoing or similar types of tape or paper are used, then of course the cleaning element 36 itself can be made of a non-abrasive material.

Other types of cleaning elements also may be used. For example, the cleaning element 36 can be a composite layer comprising abrasive grains or particles interspersed within a base material, such as shown and described in U.S. Pat. No. 6,306,187 to Maeda et al., U.S. Pat. No. 5,968,282 to Yamasaka, or U.S. Pat. No. 6,056,627 to Mizuta.

In the illustrated embodiment, cleaning element 36 is removable from the base portion 35. This allows the currently installed cleaning element 36 to be replaced with another cleaning element when the currently installed cleaning element becomes worn. In addition, different cleaning elements can be used for specific applications. For example, a cleaning element having a coating of tacky paper can be used when moderate cleaning of the probe tips is required, and a tungsten carbide cleaning element can be used when more aggressive cleaning of the probe tips is required.

In other embodiments, the cleaning element 36 can be permanently mounted to the base portion 35. For example, the cleaning member 34 can have a unitary, one-piece construction.

As shown in FIGS. 2 and 3, the cleaning member desirably includes one or more magnets 42 disposed in corresponding holes, or magnet-receiving spaces, 43 formed within the recessed portion 38 of the base portion 35. The base portion 35 desirably is made from a magnetic material, such as 410 stainless steel, so that the magnets 42 are held in their respective holes 43 by the magnetic attraction force between the magnets 42 and the base portion 35. In other embodiments, however, the base portion 35 is made from a non-magnetic material. In the latter configuration, the magnets 42 can be dimensioned to form a press fit with their respective holes 43 to hold the magnets 42 in place, or alternatively, a suitable adhesive can be used to secure the magnets 42 in their respective holes 43.

In any event, the cleaning element 36 desirably is made from a magnetic material (e.g., tungsten carbide). In this manner, the magnetic attraction force between the magnets 42 and the cleaning element 36 prevents or at least reduces any movement of the cleaning element (i.e., rotational and lateral movement) relative to the base portion 35 as the probe tips of a probe device are rubbed against the cleaning surface 44 during a cleaning cycle. If the cleaning element 36 is made of a non-magnetic material, such as ceramic, a layer of a magnetic material (e.g., steel) can be secured to the bottom of the cleaning element 36 for magnetically coupling the cleaning element 36 to the cleaning member 34.

In particular embodiments, the cleaning element 36 is made from an electrically conductive material to permit use of the cleaning element as a shorting block for testing the contact resistance of the probe tips of a probe device. One example of a suitable electrically conductive material is tungsten carbide, although other materials also can be used. If the cleaning element 36 is not made from an electrically conductive material, then the cleaning element can be removed and replaced with an electrically conductive piece of material (e.g., bronze) dimensioned to fit within the recessed portion 38 for testing the contact resistance of probe tips.

To enable easy removal of the cleaning element 36 from the base portion 35, the base portion 35 desirably is formed with a plurality of notches 46 spaced around its periphery (FIGS. 2, 3 and 5). Corresponding notches 48 desirably are formed in the side of the support member 32 below notches 46 (FIGS. 2 and 5). Notches 46, 48 are dimensioned large enough to permit a user's fingers and/or thumb to be inserted into the notches for pulling the cleaning element 36 away from the cleaning member 34.

The illustrated cleaning apparatus 30 also includes an adjustment mechanism for adjusting the tilt orientation of the cleaning member 34 relative to the probe tips of a probe device. By adjusting the tilt orientation of the cleaning member 34, the cleaning surface 44 can be “planarized” relative to the probe tips to be cleaned by the cleaning surface 44 so as to maximize contact between the cleaning surface 44 and the probe tips. As used herein, the term “planarize” means to adjust the orientation of the cleaning surface 44 so that it is parallel to a plane defined by the probe tips of a probe device within specified tolerances.

In the illustrated embodiment, for example, the adjustment mechanism comprises a plurality of adjusting screws 50 (also referred to herein as lifting screws because they “lift” the base portion 35 away from the support member 32) (FIGS. 2, 3, and 6). As best shown in FIG. 6, the adjusting screws 50 are received in corresponding threaded holes 52 extending through the base portion 35.

The adjusting screws 50 desirably are adapted to receive the blade of a conventional screwdriver for adjusting the axial position of the screws 50 in the direction of double-headed arrow A (FIG. 6). In the illustrated configuration, for example, the adjusting screws 50 are formed with slots 60 to receive the blade of a flat-head type screwdriver (FIGS. 3 and 6).

As can be appreciated from FIG. 6, the adjusting screws 50 bear against an adjacent surface of the support member 32. Hence, rotating a screw 50 (either clockwise or counter-clockwise) to adjust the axial position of the screw 50 changes the tilt orientation of the base portion 35 relative to the support member 32. Desirably, the base portion 35 includes at least three adjusting screws 50 arranged in a triangular pattern, such as shown in FIGS. 2 and 3, to allow the base portion 35, and therefore the cleaning surface 44, to be tilted in any direction depending upon how the adjusting screws 50 are selectively adjusted.

In the illustrated embodiment, as best shown in FIG. 6, a retaining screw 62 (also referred to herein as a fastening screw and a hold-down screw) extends generally coaxially through each adjusting screw 50 to secure the base portion 35 to the support member 32. In particular embodiments, each adjusting screw 50 is formed with an interior bore 54 dimensioned to receive the head 64 of an associated retaining screw 62. Each adjusting screw 50 has a generally flat base, or end wall, 58 that bears on an adjacent surface of the support member 32. Each retaining screw 62 has a threaded stem, or shaft, 66 that extends through an opening 70 formed in the end wall 58 of the associated adjusting screw 50 and is tightened into a corresponding threaded opening 68 formed in the support member 32.

An adjusting screw 50 and a retaining screw 62 can be used in other applications to impart a tilt to a first body relative to a second body or to space a first body relative to a second body. For example, a tooling plate for holding a probe card during testing, such as described in U.S. Pat. No. 6,408,500 to Orsillo (the '500 patent), can include a plurality of adjusting screws 50 to adjust the tilt orientation of the tooling plate relative to the head stage of a probe station. Retaining screws 62 can be used to couple the tooling plate to the head stage. The '500 patent is incorporated herein by reference.

In alternative embodiments, the retaining screws 62 can be laterally offset from their respective adjusting screws 50. For example, each retaining screw 62 can be situated in a side-by-side relationship with an adjusting screw 50. However, this configuration is less desirable because the retaining screws, when tightened into the support member 32, can create a bending moment in the base portion 35. The bending moment can cause warping of the base portion 35, thereby adversely affecting the planarity of the cleaning surface 44 relative to the probe tips to be cleaned. In other embodiments, the adjustment mechanism comprises adjusting screws without any retaining screws, in which case the base portion can be secured to the support member using alternative mechanisms.

In any event, to planarize the cleaning surface 44 of the illustrated embodiment relative to the probe tips of a probe device, the retaining screws 62 are loosened enough to permit rotation of the adjusting screws 50. One or more of the adjusting screws 50 are then adjusted as required to maximize contact between the cleaning surface 44 and the probe tips. When the adjusting screws 50 are set at their desired positions, the retaining screws 62 are tightened into openings 68 to retain the base portion 35 on the support member 32 and prevent movement of the adjusting screws 50. Because each retaining screw 62 extends in a generally co-axial relationship relative to a respective adjusting screw 50, the retaining screws 62 avoid creating an undesirable bending moment in the base portion 35, as can happen if the retaining screws 62 were to be spaced or offset from their respective adjusting screws 50.

In particular embodiments, the cleaning element 36 can be formed with apertures corresponding to the adjusting screws 50 such that when the cleaning element 36 is positioned in the recessed portion 38, each aperture is aligned over an adjusting screw 50. In this manner, retaining screws 62 and adjusting screws 50 can be accessed for adjusting the planarity of the cleaning surface 44 without removing the cleaning element 36.

In particular embodiments, the adjusting screws 50 have a pitch of about 80 to 120 threads/inch, with 100 threads/inch being a specific example. However, in alternative embodiments, the pitch of adjusting screws 50 can be greater than 120 threads/inch or less than 80 threads/inch, depending on the degree of precision that is required for a particular application. Where adjusting screws 50 having at least 100 threads/inch are used, the cleaning surface 44 can be planarized relative to the probe tips to at least within a tolerance of about +/−4 microns.

As best shown in FIG. 4, the illustrated support member 32 includes an upwardly extending alignment pin 72, which is received in a corresponding opening 74 formed in the base portion 35. The alignment pin 72 prevents lateral movement of the base portion 35 relative to the support member 32 when the retaining screws 62 are loosened to permit adjustment of screws 50.

As shown in FIGS. 2 and 3, screws 76, accessible through openings 78 formed in the base portion 35, extend through corresponding openings (not shown) in the support member 32 and are tightened into corresponding threaded openings (not shown) in the support bracket 40 to retain the cleaning apparatus 30 on the support bracket 40.

In working embodiments, the cleaning element 36 has a diameter of about 50 mm. Of course, the specific dimensions of the cleaning element 36 (as well as other dimensions provided in the present specification) are given to illustrate the invention and not to limit it. The dimensions provided herein can be modified as needed in different applications or situations.

To clean the probes of a probe device with the cleaning apparatus 30, the probes are brought in contact with the cleaning surface 44. The probe device is then moved relative to the cleaning apparatus, either in a lateral, side-to-side motion or in a circular motion, to cause the probe tips to rub against the cleaning surface 44. In a specific implementation, cleaning of the probe tips is carried out by an automated process in which a robotic probe-carrying device of a probe station automatically moves the probe device to the cleaning apparatus and then moves the probe device relative to the cleaning apparatus to effectuate cleaning of the probe tips. In addition, the probe station may be programmed to automatically commence a cleaning process after a predetermined number of tests.

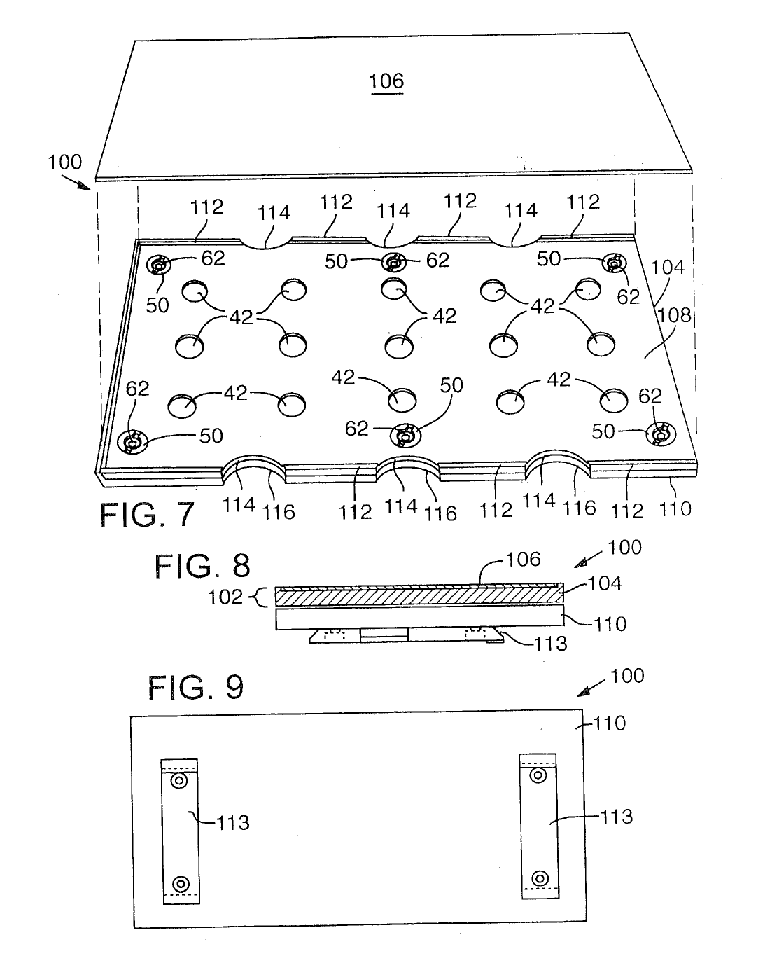

Referring to FIGS. 7-9, there is shown a cleaning apparatus 100, according to another embodiment, for cleaning the probe tips of a probe device. This embodiment shares many similarities with the embodiment of FIGS. 2-6. Hence, components in FIGS. 7-9 that are identical to corresponding components in FIGS. 2-6 have the same respective reference numerals and are not described in detail.

As shown in FIGS. 7 and 8, the cleaning apparatus 100 has a generally rectangular cleaning member 102 (FIG. 8) that comprises a base portion 104 and a removable cleaning element 106. The base portion 104 is supported by a support member 110. The cleaning apparatus 100 also has a plurality of adjusting screws 50 for adjusting the planarity of the cleaning element 106 relative to the probe tips of a probe device to be cleaned. Each adjusting screw 50 has a respective retaining screw 62 extending therethrough for retaining the base portion 104 on the support member 110.

A plurality of magnets 42 are disposed in corresponding openings formed in the base portion 104 to prevent any movement of the cleaning element 106 relative to the base portion 104 while probes are rubbed against the cleaning element 106. Notches 114 and 116 are formed in the sides of the base portion 104 and the support member 110, respectively, to facilitate removal of the cleaning element 106 from the base portion 104.

The base portion 104 may be formed with a recessed portion 108 for receiving the cleaning element 106, and a lip, or ridge, 112 extending at least partially around the recessed portion 108. As shown in FIG. 7, for example, lip 112 extends along the long sides of the base portion 104, except at notches 114. In alternative embodiments, the lip 112 extends completely around the periphery of the recessed portion 108.

As shown in FIGS. 8 and 9, removable mounting rails 113 are secured to the bottom of the support member 110. Mounting rails 113 can be used to mount the cleaning apparatus 100 to a probe station.

In working embodiments, apparatus 100 is about 100 mm in width by about 200 mm in length. In other embodiments, apparatus 100 is about 100 mm in width by about 300 mm in length.

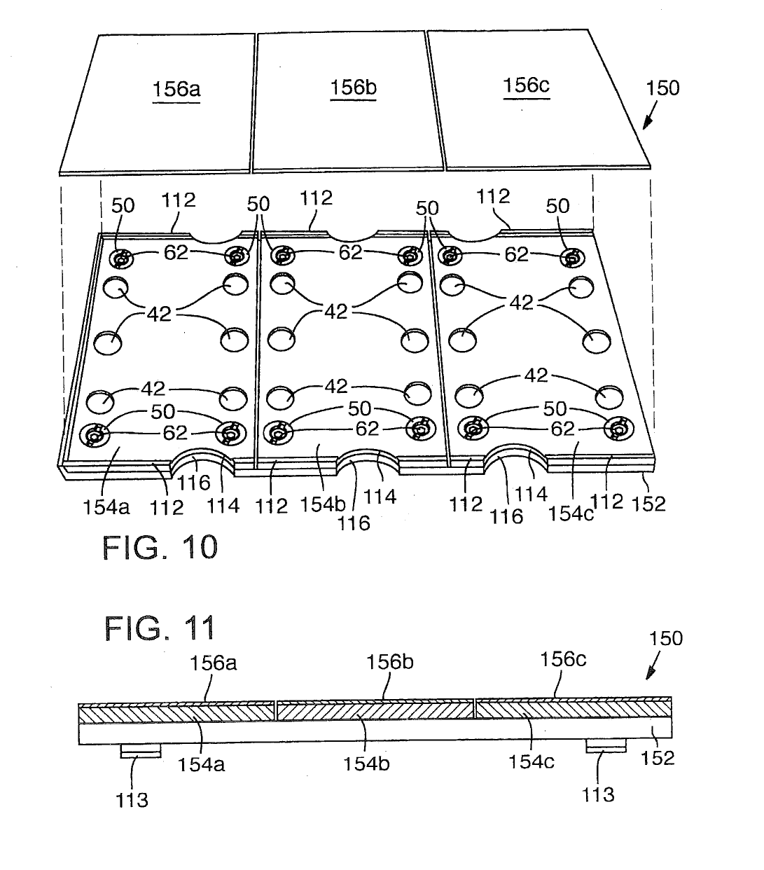

FIGS. 10 and 11 illustrate a cleaning apparatus, indicated generally at 150, according to another embodiment. This embodiment shares many similarities with the embodiment of FIGS. 7-9. The main difference between apparatus 150 and apparatus 100 of FIGS. 7-9 is that apparatus 150 is configured to support multiple cleaning elements.

As shown in FIGS. 10 and 11, cleaning apparatus 150 comprises a support member 152, multiple base portions 154a, 154b, and 156c supported on the support member 152, and multiple removable cleaning elements 156a, 156b, and 156c supported on the base portions 154, 154b, and 156c, respectively. Each cleaning element 156a, 156b, and 156c and base portion 154a, 154b, and 154c defines a separate cleaning member. In the illustrated embodiment, the cleaning apparatus 150 has three such cleaning members supported by support member 152. In alternative embodiments, however, there can be two cleaning members or more than three cleaning members.

Each base portion 154, 154b, 156c includes a set of adjusting screws 50 for independently adjusting the planarity of its respective cleaning element 156a, 156b, 156c. If desired, the cleaning elements 156a, 156b, 156c can be planarized to three different probe cards that are used with a particular probe station.

In particular embodiments, each cleaning element 156a, 156b, 156c can be made from a different material or can have a different cleaning surface for use in different cleaning applications. In one implementation, for example, one cleaning element can be a tungsten carbide cleaning element, one cleaning element can have a layer of tacky paper, and one cleaning element can be a ceramic cleaning element. In an alternative implementation, one of the cleaning elements can be a conventional cleaning brush for probes configured to fit within one of the base portions. In another implementation, one of the cleaning elements can be replaced with an electrically conductive piece of material to serve as a shorting block.

In an alternative embodiment, the cleaning apparatus can have a single adjustable base portion and plural cleaning elements supported by the base portion. For example, cleaning elements 156a, 156b, 156c of FIGS. 10 and 11 can be used with the base portion 104 and support member 110 of FIGS. 7 through 9.

The present invention has been shown in the described embodiments for illustrative purposes only. The present invention may be subject to many modifications and changes without departing from the spirit or essential characteristics thereof. I therefore claim as our invention all such modifications as come within the spirit and scope of the following claims.

I claim:

1. An apparatus for cleaning a probe device having a plurality of probes, the apparatus comprising:
a cleaning member having a cleaning surface for cleaning the probes;
a support member supporting the cleaning member;
an adjustment mechanism for adjusting a tilt orientation of the cleaning surface relative to the probes, the adjustment mechanism comprising an adjusting screw and a hold-down screw, the adjusting screw extending through the cleaning member and bearing against an adjacent surface of the support member, the hold-down screw extending generally co-axially through the adjusting screw into the support member for retaining the cleaning member on the support member, wherein when the hold-down screw is loosened to permit movement of the cleaning member relative to the support member, adjustment of the adjusting screw changes the tilt orientation of the cleaning surface relative to the probes.

2. The apparatus of claim 1, wherein the cleaning surface comprises an abrasive cleaning surface for abrasively cleaning the probes.

3. The apparatus of claim 1, wherein the adjustment mechanism comprises:
a plurality of adjusting screws, each extending generally co-axially through a corresponding threaded opening in the cleaning member and bearing against an adjacent surface of the support member, the adjusting screws being adjustable to adjust the tilt orientation of the cleaning surface relative to the probes; and
a plurality of hold-down screws, each extending generally co-axially through a respective adjusting screw into the support member, the hold-down screws preventing movement of the cleaning member relative to the support member when tightened into the support member.

4. The apparatus of claim 1, wherein the cleaning member further comprises a base portion and a removable cleaning element carried by the base portion, wherein the cleaning surface is a surface of the cleaning element.

5. The apparatus of claim 4, wherein the cleaning element is magnetically retained to the base portion.

6. The apparatus of claim 5, wherein the cleaning element is a magnetic material and the base portion has at least one magnet that magnetically retains the cleaning element against the base portion.

7. The apparatus of claim 6, wherein base portion defines a magnet-receiving space in which the magnet is disposed, and the base portion is made from a magnetic material such that the magnetic attraction force between the magnet and the base portion is sufficient to retain the magnet in the magnet-receiving space.

8. The apparatus of claim 4, wherein the base portion has a recessed portion for receiving the cleaning element and a rim extending at least partially around the recessed portion and the cleaning member to prevent movement of the cleaning element relative to the base portion while the probes are cleaned on the cleaning surface.

9. The apparatus of claim 1, wherein the support member includes an alignment pin extending into a corresponding opening in the cleaning member.

10. The apparatus of claim 1, wherein the adjusting screw has at least 100 threads per inch.

11. An apparatus for cleaning a probe device having a plurality of probes, the apparatus comprising:
a support member;
a cleaning member carried by the support member for contacting and cleaning the probes; and
an adjustment mechanism configured to adjust the a orientation of the cleaning member relative to the probes, the adjustment mechanism also configured to secure the cleaning member to the support member without creating a bending moment in the cleaning member.

12. The apparatus of claim 11, wherein the adjustment mechanism comprises:
at least one adjusting screw received in a threaded opening defined in the cleaning member and contacting an adjacent surface of the support member such that adjusting the screw causes a corresponding tilt of the cleaning member relative to the support member; and
a locking screw extending through the adjusting screw into the support member such that tightening the locking screw secures the cleaning member to the support member.

13. The apparatus of claim 12, wherein the adjusting screw has at least 100 threads per inch.

14. The apparatus of claim 11, wherein the cleaning member comprises:
an adjustable portion; and
a removable cleaning element supported by and magnetically coupled to the adjustable portion;
wherein the adjustment mechanism is configured to adjust the tilt orientation of the adjustable portion, and therefore the cleaning element, relative to the support member.

15. The apparatus of claim 14, wherein the cleaning element is made from a magnetic material and the adjustable portion has a magnet for magnetically coupling the cleaning element to the adjustable portion.

16. The apparatus of claim 15, wherein the cleaning element is made from tungsten carbide.

17. The apparatus of claim 11, wherein the cleaning member comprises:
a cleaning chuck;
a cleaning element supported on the cleaning chuck, the cleaning element having a cleaning surface for cleaning the probes, the cleaning element comprising an electrically conductive material to permit testing of the contact resistance of the probes.

18. The apparatus of claim 11, wherein the cleaning member comprises:
a plurality of cleaning chucks supported by the support member;
a plurality of removable cleaning elements supported by the cleaning chucks; and
a plurality of adjustment mechanisms for independently adjusting the tilt orientation of each cleaning chuck, and therefore each cleaning element.

19. The apparatus of claim 18, wherein one of said cleaning elements comprises an abrasive cleaning element.

20. The apparatus of claim 18, wherein one of said cleaning elements comprises a cleaning brush.

21. An apparatus for cleaning a probe device having a plurality of probes, the apparatus comprising:
a support member; and
two or more cleaning members supported by the support member and having cleaning surfaces for cleaning the probes, each cleaning member being independently adjustable to adjust the planarity of the cleaning surfaces relative to the probes.

22. The apparatus of claim 21, wherein each cleaning member comprises a cleaning chuck and a removable cleaning element.

23. The apparatus of claim 22, wherein each cleaning member further comprises an adjustment mechanism operable to impart a tilt to a respective cleaning chuck, and therefore a respective cleaning element.

24. The apparatus of claim 23, wherein each adjustment mechanism comprises:
at least one adjusting screw extending through a threaded opening in a respective cleaning chuck and bearing against an adjacent surface of the support member, such that rotation of the adjusting screw changes the tilt orientation of the cleaning chuck, and therefore the respective cleaning element; and
at least one releasable retaining screw extending through a respective cleaning chuck and capable of being tightened into the support member for retaining the cleaning chuck on the support member.

25. The apparatus of claim 24, wherein each retaining screw extends generally co-axially through a respective adjusting screw.

26. The apparatus of claim 22, wherein one of said cleaning elements comprises an abrasive cleaning element.

27. The apparatus of claim 22, wherein one of said cleaning elements is made from an electrically conductive material.

28. An apparatus for cleaning a probe device having a plurality of probes, the apparatus comprising:
a cleaning chuck having a recessed portion; and
a cleaning element dimensioned to be received in the recessed portion for contacting and cleaning the probes, the cleaning element being removable from the recessed portion.

29. The apparatus of claim 28, further comprising at least one magnet for magnetically retaining the cleaning element in the recessed portion of the cleaning chuck.

30. The apparatus of claim 29, wherein the cleaning chuck has a magnet-receiving space in which the magnet is disposed, and the cleaning chuck is made from a magnetic material such that the magnet is magnetically retained in the magnet-receiving space.

31. The apparatus of claim 28, further comprising an adjustment mechanism configured to adjust the planarity of the cleaning element relative to the probes.

32. The apparatus of claim 31, wherein the adjustment mechanism comprises a set screw extending through a threaded opening in the cleaning chuck and contacting an adjacent support surface, such that the planarity of the cleaning element relative to the probes can be adjusted by rotation of the adjustment screw, which causes a change in the tilt orientation of the cleaning member, and therefore the cleaning element.

33. The apparatus of claim 28, wherein the cleaning chuck defines a notched portion in a side surface thereof extending underneath the cleaning element, the notched portion being dimensioned to permit a user to insert a finger into the notched portion and remove the cleaning element from the cleaning chuck.

34. A method for cleaning the probe tips of a probe device used in testing semiconductor devices, the method comprising:
providing a cleaning device having a cleaning surface for contacting and cleaning the probe tips;
adjusting the tilt orientation of the cleaning device to maximize contact between the probe tips and the cleaning surface during cleaning;
securing the cleaning device to a support member without creating a bending moment in the cleaning device so as to maintain the planarity of the cleaning surface; and
cleaning the probe tips with the cleaning surface.

35. The method of claim 34, wherein the act of cleaning comprises contacting the probe tips with the cleaning surface and moving the probes relative to the cleaning surface to cause debris to be removed from the probe tips.

36. The method of claim 34, wherein the cleaning surface is electrically conductive and the method further comprises testing the contact resistance of the probe tips on the cleaning surface.

37. The method of claim 34, wherein the act of adjusting the tilt orientation of the cleaning device comprises rotating an adjusting screw extending through the cleaning device and contacting the support member to cause the cleaning device to tilt relative to the support member.

38. The method of claim 37, wherein the act of securing the cleaning device to the support member comprises tightening a retaining screw that extends through the adjusting screw into the support member.

39. An apparatus for moving a first body relative to a second body, the apparatus comprising:
a first screw adapted to be received in a threaded opening in the first body and bear on an adjacent surface of the second body such that rotation of the first screw causes the first body to move relative to the second body, the first screw defining an axially extending opening; and
a second screw extending through the opening in the first screw, the second screw having a threaded portion adapted to be tightened into a corresponding threaded opening in the second body to couple the first body to the second body once the first screw is adjusted.

40. The apparatus of claim 39, wherein the second screw has a shaft extending through the first screw and a head portion connected to the shaft, the head portion configured to bear against the first screw when the threaded portion is tightened in the corresponding threaded opening in the second body.

41. The apparatus of claim 39, wherein the second screw extends in a generally co-axial relationship relative to the first screw.

42. An apparatus for cleaning a probe device having a plurality of probes, the apparatus comprising:
a support member;
a cleaning member carried by the support member for contacting and cleaning the probes; and
means for planarizing the cleaning member relative to the probes and for securing the cleaning member to the support member while maintaining the planarity of the cleaning member.

43. The apparatus of claim 42, wherein said means comprises an adjusting screw and a hold-down screw, the adjusting screw extending through the cleaning member and bearing against an adjacent surface of the support member, the hold-down screw extending through the adjusting screw into the support member for retaining the cleaning member on the support member, wherein when the hold-down screw is loosened to permit movement of the cleaning member, adjustment of the adjusting screw changes the tilt orientation of the cleaning surface relative to the probes.

44. An apparatus for cleaning a probe device having a plurality of probes, the apparatus comprising:
a support member, the support member having an alignment pin;
a cleaning chuck carried by the support member, the cleaning chuck defining a recessed portion and a rim extending at least partially around the recessed portion, the cleaning chuck having a magnet-receiving space and an opening dimensioned to receive the alignment pin of the support member;
a magnet disposed in the magnet-receiving space;
a removable cleaning element disposed in the recessed portion of the cleaning chuck, the cleaning element having a cleaning surface for contacting and cleaning the probes of the probe device, the cleaning element being made from a magnetic material such that the cleaning element is magnetically retained in the recessed portion by the magnet;
a plurality of adjusting screws extending through corresponding threaded openings defined in the cleaning chuck and contacting the support member such that rotating the screws causes a corresponding tilt of the cleaning chuck, and therefore the cleaning element; and
a plurality of fastening screws, each of which extends through a respective adjusting screw and is tightened into the support member to prevent movement of the cleaning chuck once the cleaning chuck is adjusted to a desired tilt orientation.
